(19) United States
(12) Patent Application Publication
(10) Pub. No.: US 2005/0253352 A1
(43) Pub. Date: Nov. 17, 2005

(54) Semi-trailing arm high cube rear suspension

(76) Inventor: James F. Ziech, Kalamazoo, MI (US)

Correspondence Address: DYKEMA GOSSETT PLLC, SUITE 300, 39577 WOODWARD AVENUE, BLOOMFIELD, MI, 48304, US

(21) Appl. No.: 10/846,454

(22) Filed: May 14, 2004

(51) Int. Cl. B60G 7/02

(52) U.S. Cl. 280/124.128

(57) ABSTRACT

An improved semi-trailing arm rear suspension is provided for use in vehicles having low floors. The suspension positions the outboard pivot attachment further outboard than the longitudinal centerline of the wheel to improve reaction during vehicle braking. The suspension may also place the pivot axis below the rotational axis of the wheel in order to maximize available cargo space and at a slight angle to the rotation axis of the wheel to improve vehicle handling.

### BACKGROUND OF THE INVENTION

1. Field of the Invention

The present invention relates to a vehicle suspension, and more particularly, to independent rear suspension for a low floor vehicle.

2. Discussion of Related Art

A conventional independent rear suspension is used to support the wheels of a vehicle in which a wide and low cargo floor is desired. In particular, the suspension can be used in connection with non-driving wheels, for example, with a trailer or with the rear wheels of a front wheel drive vehicle. In an independent rear suspension, the two rear wheels are sprung independently from each other. The advantages of an independent rear suspension over a beam axle suspension, in which an axle extends the width of the vehicle below the vehicle frame, is that a larger trunk or cargo area can be placed between the wheels. Moreover, handling over rough road surfaces can be improved using an independent rear suspension.

One type of conventional independent rear suspension is a trailing arm independent rear suspension. In a trailing arm independent rear suspension, the pivot axis is parallel to the rotational axis or perpendicular to the vehicle's longitudinal axis. Therefore, in a trailing arm suspension, the wheels are always upright relative to the vehicle frame and there is no camber change relative to the vehicle body.

The trailing arm independent rear suspension may be distinguished from a semi-trailing arm independent rear suspension. In particular, in a semi-trailing arm independent rear suspension, a roughly triangular suspension arm supports a wheel for rotation about a rotational axis. The suspension arm is coupled to the vehicle frame and pivots at two points. The outboard and inboard pivot points are coaxial about a pivot axis. The pivot axis is angled from the rotational axis and is usually between parallel and perpendicular to a vehicle's longitudinal axis. A semi-trailing arm suspension provides for rear wheel camber to improve handling and cut tire wear.

Conventional independent rear suspensions may have several drawbacks. First, conventional independent rear suspensions create a large load on the pivot attachments during braking due to the fore/aft moment and may create an unwanted toe change in which the front of the wheel is angled in toward the vehicle or out away from the vehicle. Second, conventional independent rear suspensions do not maximize the available cargo space or may suffer from low ground clearance. Third, conventional independent rear suspensions may have adverse wheel camber.

The inventors herein have recognized a need for a vehicle suspension that will minimize and/or eliminate the above-identified deficiencies.

### SUMMARY OF THE INVENTION

The present invention provides an independent rear suspension for a vehicle. The suspension includes a suspension arm supporting a wheel for rotation about a rotational axis. The suspension arm is coupled to a vehicle frame at both inboard and outboard pivot attachments. The axial midpoint of the outboard pivot attachment along a pivot axis of the outboard and inboard pivot attachments is outboard of a longitudinal centerline of the wheel.

A suspension in accordance with the present invention is advantageous as compared to existing independent rear suspensions. In particular, the location of the outboard pivot attachment relative to the wheel enables a better reaction to braking force. Specifically, this configuration serves to reduce moment in the fore/aft direction about the pivot attachments to avoid a toe change in the wheel. Various embodiments of the inventive suspension may also improve cargo space, reduce the chance of damage during a tire blowout or flat and control camber change to improve handling.

These and other features and objects of this invention will become apparent to one skilled in the art from the following detailed description and the accompanying drawings illustrating features of this invention by way of example.

### BRIEF DESCRIPTION OF THE DRAWINGS

FIG. 1 is a top view of the vehicle suspension in accordance with a first embodiment of the present invention.

FIG. 2 is a side view of a suspension in accordance with the first embodiment of the present invention.

FIG. 3 is a side view of a vehicle suspension in accordance with a second embodiment of the present invention.

FIG. 4 is a side view of a vehicle suspension in accordance with a third embodiment of the present invention.

FIG. 5 is a side view of a vehicle suspension in accordance with a fourth embodiment of the present invention.

### DETAILED DESCRIPTION OF EMBODIMENTS OF THE INVENTION

Referring now to the drawings wherein like reference numerals are used to identify identical components in the various views, FIG. 1 illustrates a portion of a vehicle frame 10 supported on one or more wheels 12 through a vehicle suspension 14 in accordance with one embodiment of the present invention. The inventive suspensions disclosed herein are designed for use in low floor vehicle including those designed to transport people (i.e., buses) and/or cargo. It should be understood, however, that the inventive suspension could be used on other vehicle types.

Frame 10 is provided to support various components of the vehicle and is conventional in the art. Frame 10 may include includes conventional rail members 16 extending in the longitudinal direction of the vehicle generally parallel to one another and one or more cross members 18, 20 extending transversely relative to the rail members. Frame 10 may further include additional structure supported on members 16, 18, 20 and forming cubes or wells 21 in which part or all of wheels 12 and suspension 14 may be disposed. Cross member 18 may include a pair of plates 22, 24 extending rearward from cross member 16 near the outboard edge of the vehicle and forming a mounting bracket. A second pair of plates 26, 28 may extend rearward from cross member 18 inboard from the location of the first set of plates 22, 24 to form another mounting bracket. Plates 22, 24, 26, 28 are slightly angled from the longitudinal axis of the vehicle and the rotational axis 30 of wheels 12 toward the outboard edge of the vehicle. Plates 22, 24, 26, 28 each contain an aperture 32 to facilitate attachment of the suspension 14 as described hereinbelow.

Wheels 12 are provided to support the vehicle on a road surface and are conventional in the art. Wheels 12 are disposed about rotational axes such as axis 30. In the illustrated embodiment, a single wheel is shown. It should be understood, however, that suspension 14 could support a plurality of wheels 12. Wheel 12 has a longitudinal centerline 34 as shown in FIG. 1 extending perpendicular to axis 30. Wheel 12 is a non-driving wheel and may, for example, be found in a trailer or may be the rear wheel in a front-wheel drive vehicle. It will be appreciated that a similar wheel and a suspension system are used on the opposite side of the vehicle.

Suspension 14 is provided to couple frame 10 and wheels 12 and to dampen movement between frame 10 and wheels 12. Suspension 14 may include a suspension arm 35, a spring 36, and a shock absorber 38.

Suspension arm 35 is provided to couple frame 10 and wheel 12. Arm 35 may include a body 40, pivot attachments 42, 44 and a spring support 46.

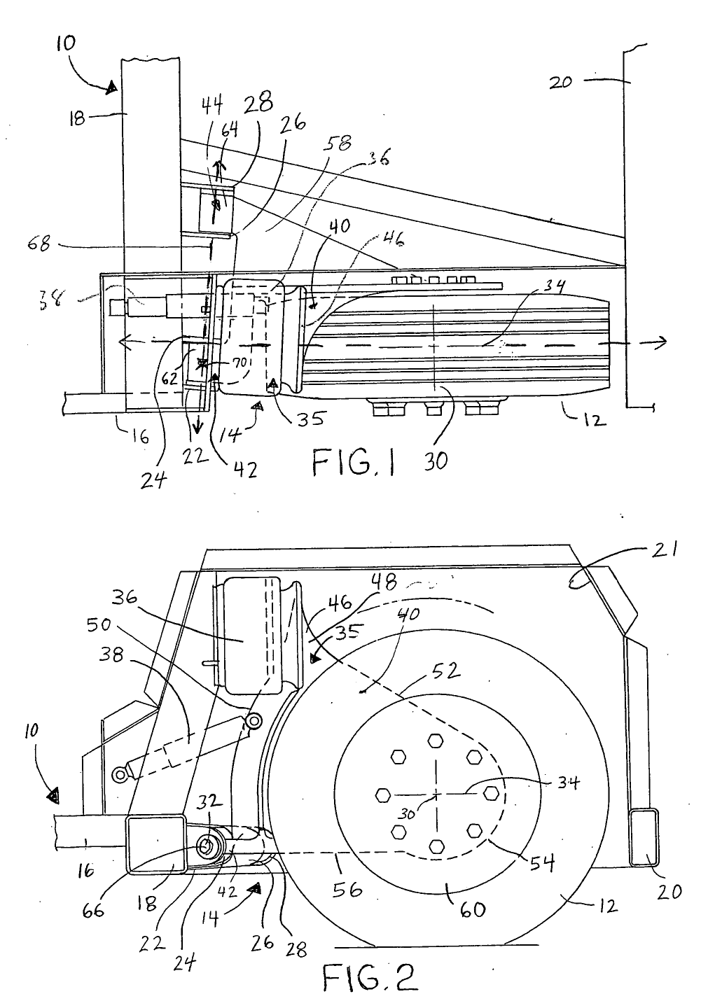

As shown in FIG. 2, body 40 of arm 35 may include a generally vertically extending portion 48 that is substantially triangular in shape when viewed transversely relative to the vehicle. A first side 50 of portion 48 runs from approximately pivot attachments 42, 44 to spring support 46. A second side 52 of portion 48 runs down from spring support 46 to a wheel mounting point 54. A third side 56 runs from pivot attachments 42, 44 to the wheel mounting point 54. Body 40 may further include a generally horizontally extending portion 58 integral with portion 48. In the illustrated embodiment portion 58 is triangular in shape on an inboard side of portion 48. Portion 58 extends outward on an outboard and inboard side of portion 48 such that portion 58 joins pivot attachments 42, 44. As illustrated in FIG. 2, suspension 14 has a lowest point higher than a lowest point of a rim 60 of wheel 12. In the event of a flat tire, therefore, suspension 14 is less likely to suffer damage than many conventional suspensions used in similar applications.

Pivot attachments 42, 44 are provided to allow pivotal movement of suspension arm 35 relative to frame 10 during jounce and rebound as wheel 12 encounters irregularities in the road surface. Pivot attachments 42, 44 may include sleeves 62, 64 formed integral with portion 58 of body 40 of arm 35 and extending generally forward in the longitudinal direction of the vehicle. Each sleeve defines an aperture configured to receive a conventional bushing. Fasteners such as a pin 66 extend through each bushing and are received within corresponding apertures 32 in plates 22, 24 and 26, 28.

Referring to FIG. 1, pivot attachments 42, 44 are coaxial along a pivot axis 68. Pivot attachment 42 is located further outboard along pivot axis 68 while pivot attachment 44 is located further inboard along pivot axis 68. In accordance with the present invention, outboard pivot attachment 42 may be aligned with the longitudinal centerline 34 of wheel 12 or may be disposed completely outboard of longitudinal centerline 34 such that the axial midpoint 70 of attachment 42 is outboard of centerline 34. By aligning outboard pivot attachment 42 such that at least a portion of pivot axis 68 is outboard of the longitudinal centerline 34 of wheel 12, a reduction in transverse or twisting forces on the suspension arm is achieved and the suspension reacts well to braking while limiting any change in toe of the wheels 12. Pivot axis 68 is also located below rotational axis 30 of wheel 12 in the illustrated embodiment. In this configuration, pivot attachments 42, 44 may be disposed below the floor of the vehicle to provide maximum cargo space. Pivot axis 68 may also be angled relative to rotational axis 30 of wheel 12. The angled pivot axis 68 allows for a small camber change, favorable for keeping the wheel more closely configured to be perpendicular to the road during a cornering event. Both pivot attachments may be placed forward of the wheel and below the vehicle floor to enable the vehicle to have the largest amount of cargo space. Inboard pivot attachment 44 is spaced relatively far from outboard pivot attachment 42 to facilitate improved reaction during braking.

Spring support 46 provides a seat to support spring 36 disposed between suspension arm 35 and vehicle frame 10. Spring support 46 may comprise a flat plate located essentially at the apex of portion 48 of body 40 of arm 34. Spring support 46 is located above the pivot attachments 42, 44 and pivot axis 68. More particularly, spring support 46 may be centered above pivot attachments 42, 44 and pivot axis 68.

Spring 36 is provided to dampen movement between frame 10 and wheels 12. Spring 36 is conventional in the art and may comprise an air spring or a metal spring, such as a coil spring. Spring 36 is disposed between arm 35 and vehicle frame 10 and may be located at or above pivot axis 68. Spring 36 acts in the fore-aft direction of vehicle travel in the illustrated embodiment.

Shock absorber 38 is also provided to dampen movement between frame 10 and wheels 12 and is conventional in the art shock absorber 38 may be coupled between suspension arm 35 and vehicle frame 10. As illustrated in FIG. 2, shock absorber 38 may be positioned below spring 36 as a separate element from spring 36. Shock absorber 38 is attached to the vehicle frame at a first end and to suspension arm 35 at a second end. More specifically, the first end of shock absorber 38 is attached to vehicle frame 10 at a point forward of pivot attachments 42, 44. The second end of shock absorber 38 is attached to suspension arm 35 at a point below spring support 46. The first end of shock absorber 38 is positioned below the second end of shock absorber 38.

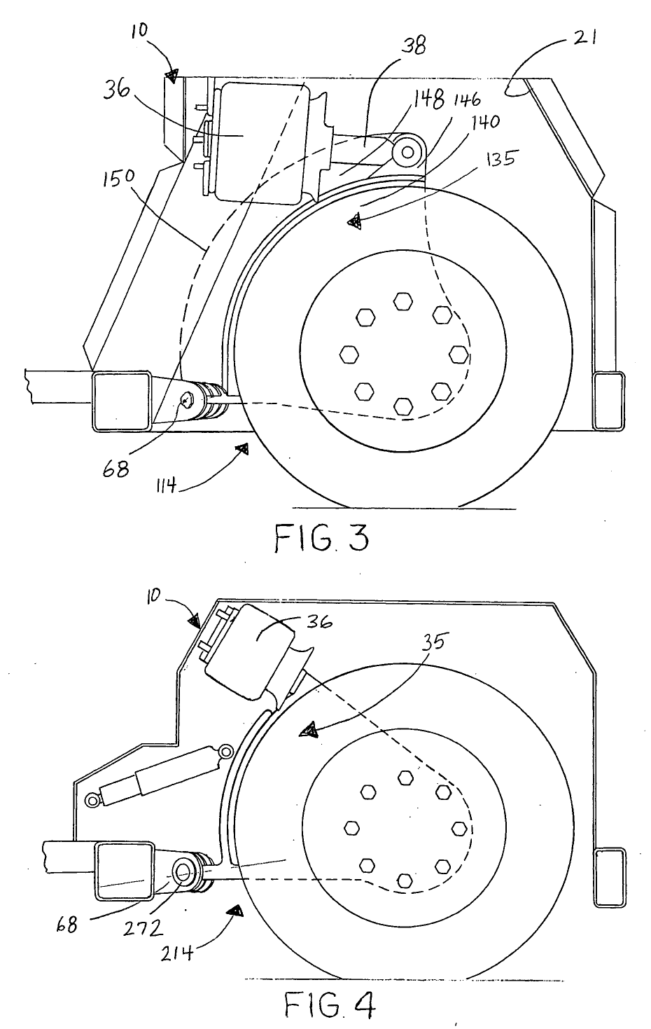

Referring now to FIG. 3, another embodiment of a suspension 114 in accordance with the present invention is illustrated. Suspension 114 is substantially similar to suspension 14, but with modifications to allow spring 36 and shock absorber 38 to be combined into a single shock/spring unit. In particular, one side 150 of portion 148 of body 140 of arm 135 assumes a substantially curved line to allow support 146 to be moved rearwardly within well 21. Support 146 is configured to receive the eye of shock absorber 38. Shock absorber 38 is attached to spring 36 at a first end and to support 146 at a second end. More specifically, the first end of shock absorber 38 is attached to a center point of spring 36. The second end of shock absorber 38 is attached to suspension arm 135 at a point above the center of wheel 12. The first end of shock absorber 38 is positioned approximately level with the second end of shock absorber 38. The shock spring unit is disposed between arm 135 and vehicle frame 10 and may be located at or above pivot axis 68. The shock/spring unit acts in the fore-aft direction of vehicle travel in the illustrated embodiment.

Referring now to FIG. 4, another embodiment of a suspension 214 in accordance with the present invention is illustrated. Suspension 214 is again substantially similar to suspension 14. Suspension 214 includes a different arrangement of spring 36, however, along with the addition of a spring 272 which may comprise a torsion bar spring. In suspension 214, spring 36 is angled relative to the fore-aft direction of vehicle travel and, in particular, less than ninety degrees relative to the fore-aft direction of vehicle travel. Spring 272 is provided to reduce some of the spring load on spring 36 to thereby allow a reduction in size of spring 36. Spring 272 is splined along pivot axis 68 and is connected to arm 35 in such a manner that suspension arm 35 is supported and may still pivot.

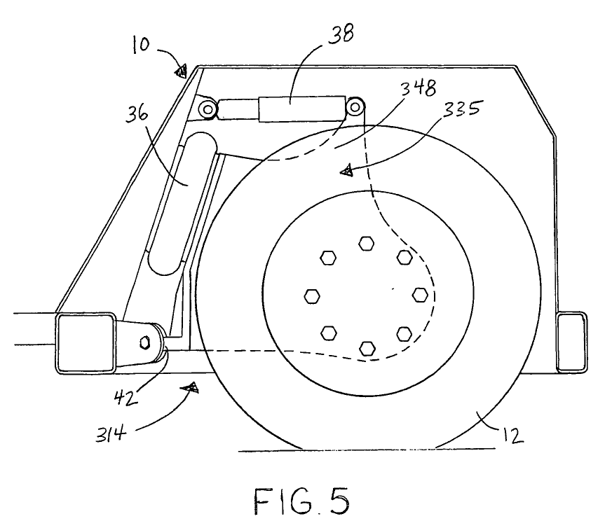

Referring now to FIG. 5, another embodiment of a suspension 314 in accordance with the present invention is illustrated. Suspension 314 is substantially similar to suspension 14, but includes yet another arrangement for the spring 36 and shock absorber 38. In particular, the shape of portion 348 of arm 335 is modified to allow repositioning of spring 36 and shock absorber 38. In suspension 314, shock absorber 38 is positioned above spring 36 as a separate element from spring 36. Shock absorber 38 is attached to vehicle frame 10 at a first end and to arm 335 at a second end. More specifically, the first end of shock absorber 38 is attached to vehicle frame 10 at a position rearward of pivot attachments 42, 44 and above spring 36. The second end of shock absorber 38 is attached to suspension arm 335 at a point above the center of wheel 12. The first end of shock absorber 38 is positioned approximately level with the second end of shock absorber 38. Also in this embodiment, spring 36 is positioned on suspension arm 335 at an angle relative to the fore-aft direction of vehicle travel.

A suspension in accordance with the present invention is advantageous compared to conventional suspensions. The inventive suspension includes a configuration in which the outboard pivot attachment is pushed outboard and the pivot axis is located below the rotational axis, thereby allowing maximum cargo space. The pivot attachments are also placed forward of the wheel and below the cargo floor with the pivot axis disposed below the rotational axis of the wheel in order to maximize available cargo space. The inventive suspension arm also has a lowest point higher than the bottom of the wheel rim in order to improve ground clearance. The inventive suspension also includes a configuration in which the pivot axis is angled relative to the rotational axis to create a small camber change when cornering to maintain the wheel more closely to perpendicular to the road surface. In addition to maximizing cargo space, because the outboard pivot attachment is placed outboard of the wheel longitudinal center plane, spaced well apart from the inboard pivot attachment, a better reaction to braking force is provided. Specifically, this configuration serves to reduce moment in the fore/aft direction about the pivot attachments to avoid a toe change. A spring or shock/spring unit is placed above the center of the pivot axis to most effectively cushion the vehicle as it encounters irregularities in the road surface. In another embodiment of the invention, a torsion bar spring may be disposed about the pivot axis and located under the cargo floor to reduce the size of the spring or shock/spring unit, thereby serving to further maximize cargo space.

While the invention has been particularly shown and described with reference to the preferred embodiments thereof, it is well known by those skilled in the art that various changes and modifications can be made in the invention without departing from the spirit and scope of the invention.

1. A vehicle suspension, comprising:
a suspension arm supporting a wheel for rotation about a rotational axis and coupled to a vehicle frame at inboard and outboard pivot attachments wherein an axial midpoint of said outboard pivot attachment along a pivot axis of said outboard pivot attachment is outboard of a longitudinal centerline of said wheel.

2. The suspension of claim 1 wherein said inboard and outboard pivot attachments are coaxial about said pivot axis, and said pivot axis is angled relative to said rotational axis.

3. The suspension of claim 1 wherein said pivot axis is disposed below said rotational axis.

4. The suspension of claim 1 wherein a lowest point of said suspension arm is located above a lowest point of a rim of said wheel.

5. The suspension of claim 1 wherein said inboard and outboard pivot attachments are positioned forward of said wheel and below a floor of said vehicle frame.

6. The suspension of claim 1 further comprising a spring disposed between said suspension arm and said vehicle frame wherein said spring is located above said pivot axis.

7. The suspension of claim 6 wherein said spring acts in a fore-aft direction relative to the direction of vehicle travel.

8. The suspension of claim 6 wherein said spring is angled at less than 90 degrees relative to a fore-aft direction of vehicle travel.

9. The suspension of claim 6 wherein said spring is centered above said pivot axis.

10. The suspension of claim 1 further comprising a shock/spring unit disposed between said suspension arm and said vehicle frame wherein said shock/spring unit is located above said pivot axis.

11. The suspension of claim 10 wherein said shock/spring unit acts in a fore-aft direction relative to the direction of vehicle travel.

12. The suspension of claim 10 wherein said shock/spring unit is angled at less than 90 degrees relative to a fore-aft direction of vehicle travel.

13. The suspension of claim 10 wherein said shock/spring unit is centered above said pivot axis.

14. The suspension of claim 1 further comprising a spring disposed about said pivot axis.

15. The suspension of claim 1 wherein said inboard and outboard pivot attachments comprise bushings.

16. A vehicle suspension, comprising:
a suspension arm supporting a wheel for rotation about a rotational axis and coupled to a vehicle frame at inboard and outboard pivot attachments wherein said inboard and outboard pivot attachments are coaxial about a pivot axis, said pivot axis angled relative to said rotational axis and disposed below said rotational axis, and an axial midpoint of said outboard pivot attachment is outboard of a longitudinal centerline of said wheel.

17. The suspension of claim 16 further comprising a spring disposed between said suspension arm and said vehicle frame wherein said spring is located above said pivot axis.

18. The suspension of claim 16 further comprising a shock/spring unit disposed between said suspension arm and said vehicle frame wherein said shock/spring unit is located above said pivot axis.

19. The suspension of claim 16 further comprising a spring disposed about said pivot axis.
